(19) United States
(12) Patent Application Publication
(10) Pub. No.: US 2015/0188428 A1
(43) Pub. Date: Jul. 2, 2015

(54) High Efficiency Voltage Conversion and Converter

(71) Applicant: Diodes Incorporated, Plano, TX (US)

(72) Inventor: Frederick Leung, Cupertino, CA (US)

(21) Appl. No.: 14/581,058

(22) Filed: Dec. 23, 2014

Related U.S. Application Data
(60) Provisional application No. 61/923,081, filed on Jan. 2, 2014.

(51) Int. Cl. H02M 3/158

(52) U.S. Cl. CPC H02M 3/158

(57) ABSTRACT

A novel switching power converter comprises a state machine. The state machine continuously seeks an optimal switching timing of a switch in the converter for maximum system efficiency. The state machine moves the triggering edge of a switching signal that triggers a second switch in a controlled step and direction with respect to a prior signal, and measures the on-time during which power goes into the converter. The measured on-time is then compared to a reference to determine the correctness of the movement. The movement of the triggering edge continues to maintain maximum conversion efficiency.

### BACKGROUND

Voltage converters are used to convert the voltage of a power source to a regulated and predetermined voltage. They are typically used in battery chargers and hand-held electronic devices. The voltage at the power source may be at a higher or lower level than the predetermined voltage, or it may fluctuate. Generally speaking, there are two types of converters: the linear converters and the switching converters. Switching converters tend to be more energy efficient compared than linear converters.

Switching voltage converter employs one or more switches (e.g., power transistors) and inductive and capacitive energy storage elements to convert current pulses into a steady load current. A typical modern switching voltage converter system employs two synchronized transistors in such a way that the two transistors alternate in conducting current. A typical synchronized voltage converter has two input terminals to receive the to-be-converted input voltage V_{IN}. A pair of field effect transistors (FETs), for example, is connected between the input terminals—a transistor adjacent to the high rail of the input voltage is known as the control or high side FET, and a transistor adjacent to the ground is known as the synchronous (sync) or low side FET. The node where the transistors joined is known as the switch node, and connected to it is an inductor and a capacitor and the load.

The converter controls the amount of energy by regulating the cycle time or the frequency of the switching via a control circuit. During the half cycle when the control FET is turned on, current flows from the high rail to the load and charges the inductor. When the sync FET is turn on during the other half cycle energy stored in the inductor flows to the low rail through the sync FET. The control circuit senses the voltage at the output via a feedback path and issues corresponding control signals to control the switching of the FETs.

It is known in the art that during operation, if both transistors are switched on, current will flow directly between the two input terminals (a phenomenon known as “shoot-through”), and converts into wasteful heat in the FETs. To avoid shoot-through, most converters are designed to incorporate a “dead-time” in the switching timing scheme, during which both FETs are off before either FET is switched back on.

Dead-time, however, is detrimental to the converter efficiency. This is because even though during the dead time the channel of the sync FET is turned off, the inductor current still flows through the sync FET via the parasitic body diode. Since the voltage across the forward biased body diode is higher than the threshold voltage of the sync FET, the power loss in the sync FET during the dead-time is higher than if the sync FET is turned on. Schemes designed over the past decades to reduce dead-time.

In most attempts a dedicated control circuitry first seeks a voltage or a current signal at near the FETs. The circuitry needs to receive, recognize, and manipulate the signals before delivers the information to the switching circuitry to modify the switching of the FETs at the next cycle. One exemplary scheme monitors the voltage on the switch node for a sign that the control FET is safely switched off and the inductor is drawing current through the parasitic body diode of the sync FET and the body diode is being forwardly biased at about 0.8 V at the drain terminal with respect to the source terminal of the sync FET. When the control circuit senses this voltage at the switch node falling below the predetermined value, it then sends a signal that starts a chain of events in the control circuit that lead to the triggering to turn on the sync FET.

### SUMMARY

The Inventor recognizes that the approaches such as described in the previous paragraphs share one common flaw—they all depend on a control circuitry being capable of receiving a measurement of magnitude and timing of a voltage or current to pinpoint the switching state of one FET and reacts to affect the switching state of the other FET almost contemporaneously. This requires, in real systems, sophisticated and stable circuitry in order to measure and to process signal or signals before conveying the results to incorporated it into the signal that triggers the target FET immediate next switching cycle. Inherently and unavoidably, there are component offsets, finite time lapses between the measurement and the switching of the FET as a result of the accumulated signal propagation delays in various portions of the system. The aging of the system components exasperates the problem.

Realizing this, the Inventor endeavored to invent a novel approach that optimizes the system conversion efficiency. The novel approach utilizes a state machine, which continuously monitors the power input into the converter through a switch and manipulates the timing of a trigger pulse directed to another converter component in a way that results in less energy passing through the switch. The principle of the novel approach is described below.

The relationship between the energy, that goes into the converter (E_{IN}) in terms of time-power product, the energy that is delivered to the load to do work (E_{OUT}), the energy that is lost (E_{L}) in the system due to the conversion inefficiency, and the overall efficiency (η) of the converter can be expressed in the following equations:

E_{IN}=E_{OUT}+E_{L} (1)

η=E_{OUT}/E_{IN} (2)

For a fixed E_{OUT}, such as during a time period when the demand of power to a load is deemed constant, the efficiency of the converter η improves if the power input E_{IN} can be reduced. In a switching voltage converter, E_{IN} may be expressed as the sum of the bursts of power (voltage times current) that flow from the power source through the control FET to the converter:

E_{IN}=ΣV_{IN}×I_{IN}×T_{ON} (3)

In equation (3) V_{IN} is the input voltage, I_{IN} is the input current, and T_{ON} is the on-time of the control FET of the switching cycles. It is well known in the art of switching power supply that the pulses that switch the FETs are bi-level. The switched FET stays in the on state when the switching pulse is in one of the bi-levels and stays off when the switching pulse is at the other level. For the purpose of explaining the invention, the measurement of the duration of the switching pulse at the “on” level is equivalent to measuring the on-time of the FET, while the duration of the “off” level of the switching pulse is equivalent to the off-time of the FET.

Assuming that over time, V_{IN} and I_{IN} can be represented by their respective average value, then (3) may be rewritten as

E_{IN}=V_{IN(AV)}×I_{IN(AV)}×ΣT_{ON}=K×ΣT_{ON.} (4)

That is, the energy that flows into the converter is a linear function of the total time during which the control FET is switched on.

From equations (1) through (4), it is clear that a converter can approach its maximal efficiency for a given load condition and a power source, by adaptively minimizes the on-time of the control FET. This principle may be applied in various converter systems, and may be practiced in various ways. The following exemplary process explains how to implement this principal with a state machine. In this context, a state machine is a computer or a sequential logic circuit that can be programed to execute a program of logic and computational steps including decision making steps.

In a first step, the state machine interrogates the on-time of the control FET during one switching cycle and store the interrogation result. In the following switching cycle, a step is taken to add to or subtract a known amount to move the triggering edge of the signal pulse that turns off the sync FET. The state machine then interrogates on-time of the control FET at the next switching cycle and compares with the previously stored on-time value. If the comparison reveals that the new on-time has decreased, then the state machine will stay the course and continue to move the triggering edge of the subsequent signal pulses until the comparison result changes sign, which signals that the on-time has increased in the just measured switching cycle. Once the comparison result changes sign, the state machine will continue to move the edge of the triggering edge at the next switching cycle but in the opposite direction until the sign changes again.

A complementary process suitable for converters with constant on-time only changes the target of interrogation to the off-time of control FET. The state machine will then move the triggering edge to the sync FET in the direction to increase the off-time of the control FET.

In the following, the structure of an exemplary converter that embodies this invention is summarized. The converter includes a state machine that has a counter circuitry for interrogating a pulse train based on a system clock, a storage circuitry for storing the result of the counting, a comparator for comparing the stored count to a reference count, and a modulator circuitry for adjusting the timing of a second pulse train based on the comparison result. In this exemplary converter, the first pulse train drives the control FET and the second pulse train drives the sync FET.

With a constant frequency converter, either the on-time or off-time of the control FET can serve as the target of interrogation. The modulator circuit then adjusts the timing of the subsequent triggering edges of the pulse that switches on the sync FET based on the result.

By incorporating in a converter a state machine that is capable of monitoring the duty cycle of a first pulse train and then adjusting the timing of a related second pulse train, one can improve the efficiency of the converter independent of converter topologies. And because it is adaptive, it is self-correcting and therefore the inherent and unavoidable component offsets, finite time delays in various portions of the system and the aging of the system components are irrelevant to the function of the state machine and will not hinder its effectiveness.

### BRIEF DESCRIPTION OF DRAWING FIGURES

FIG. 1 depicts an embodiment of the invention.

FIG. 2 depicts another embodiment of the invention.

### DETAILED DESCRIPTION OF THE EMBODIMENTS

### Example 1

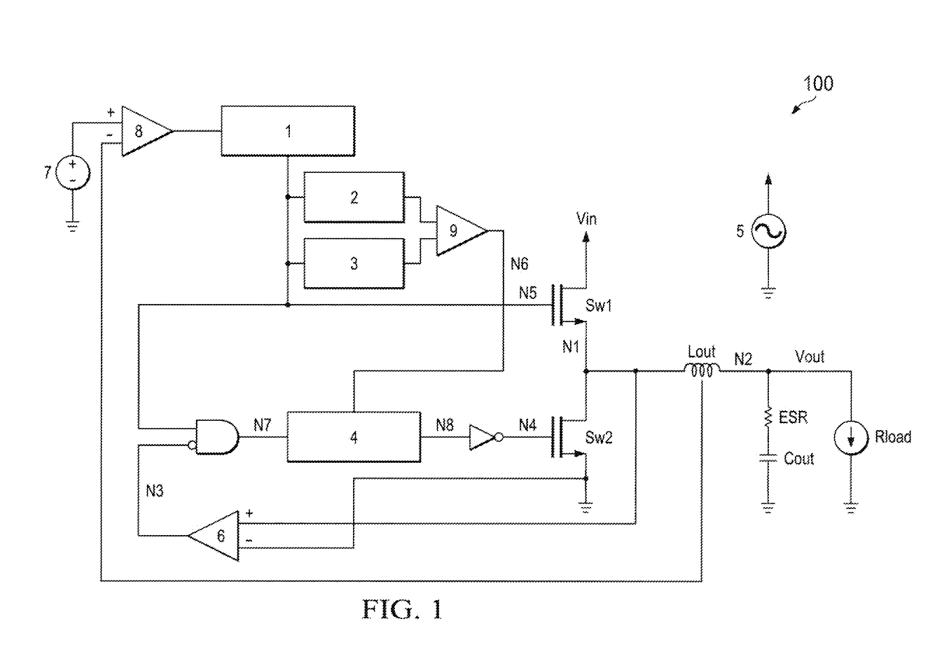

Depicted in FIG. 1 is a voltage converter 100 adopted to supply at the output terminal a steady voltage V_{OUT}. It draws power from a voltage supply terminal V_{IN}. The input voltage V_{IN} may be unstable and its value may vary with time such as with a battery, which tends to lose its charge with time.

The voltage converter 100 in this example operates with a system clock 5 having an operating frequency of 64 MHz and a clock cycle of 15.6 pico-seconds. Clocks of other frequencies may be used depending on the application.

The converter 100 has two switches, Sw1 and Sw2, which in this example are MOSFETs. Other types of switches such as bipolar transistors may also be used depending on the application.

The switches Sw1 and Sw2 are switched on and off by a pulse train from a constant time trigger unit 1. The frequency and the duty cycle of pulse train is modulated by a comparator 8, which receives a reference voltage V_{REF} 7 and a feedback voltage signal 10 from the output terminal of the converter,

The constant time trigger unit 1 is configured so the pulse width T_{ON} that turns on the control FET Sw1 is constant, The switching cycle is significantly longer than the clock cycle of the system clock 5. When the switch Sw1 is switched on, the switch Sw2 stays off and power flows from the terminal V_{IN} and is stored in the inductor L_{OUT} and charges the capacitor C_{OUT}.

After Sw1 is turned on for the duration of T_{ON}, the constant time trigger unit triggers Sw1 to switch it off for the duration of T_{OFF}. During T_{OFF} Sw2 switches on and current flows from the inductor through Sw2 and charges the capacitor C_{OUT}. So the two switches act almost contemporaneously with only a “dead time” between when Sw1 is switched off and Sw2 turns on.

Following the current through Sw2 during T_{OFF}, one can trace the two parallel paths through which the power is converted to heat and lost instead work done in the load. The sync FET Sw2 has a body diode in parallel to the FET channel. When the body diode alone is conducting while the FET channel is switched off, the power loss through Sw2 is the product of the current and the voltage sustained across the diode, which is about 0.8 volts or higher. When the FET is switched on, current can flow through the FET channel and the power loss is the product of the current and the voltage drop across the channel, which is about 0.4 volts or lower. It is thus clear that one can reduce the power loss by minimizing the time when current is forced to pass through only the body diode. However, it is more undesirable to have both FETs in the on-state because then current from V_{IN} would surge through both FETs to the ground almost unimpeded—a phenomenon known as shoot-through.

In the converter depicted in FIG. 1 the state machine achieves the optimal switching timing of the two FETs by dithering the triggering pulse edge that turns on the sync FET Sw2 about an optimal point by monitoring the increase or decrease of the power into the converter. This is a far more effective way compared to monitoring the voltage at the switch node and trying to time the triggering of Sw2 as commonly employed in the known art.

In this implementation a counter 2 counts and stores the T_{OFF} time of the pulse train that drives Sw1, a comparator 9 compares the stored T_{OFF} time with a stored count value, and a pulse edge modulator 4 modulates the triggering edge of the subsequent pulse to the sync FET Sw2.

The counter 2 measures T_{OFF} of the pulse that drives Sw1 and feeds the information to the comparator. Counter 3 stores the T_{OFF} count of the previous switching cycle. The pulse edge modulator 4 receives the output of the comparator 9 and acts by moving the triggering edge of the pulse forward or backward accordingly. The amount of movement may be a function of the system clock. For example, the amount of movement may equal to one clock cycle (15.6 pico-seconds), or an integral number or a fraction of, or other function of the system clock cycle, or it may follow a look-up table based on the number of consecutive positive or negative determinations at the comparator 9.

The pulse edge modulator 4 drives the sync FET Sw2 Because of the choice of the movement of the triggering edge by the state machine is always in the direction to increase the T_{OFF} of Sw1, for a given constant T_{ON}, the maximum system efficiency is thus reached and maintained when the T_{OFF} is kept at its maximum.

As a precursor, the state machine stores in a storage element 3 the duration, as an integral number of the system clock cycles, of the turn-off time T_{OFF1} of the control FET Sw1 during a switching cycle. In the next switching cycle, the triggering edge of a pulse that turns on the sync FET Sw2 is moved forward (delayed) by a certain amount with respect to the timing in the previous switching cycle. The amount may be one cycle of the system clock 5. The state machine then operates to have the turn-off time T_{OFF2} of the control FET Sw1 measured and stored in a storage element such as element 2 in FIG. 1 following the movement of the triggering edge. The count in element 2 is compare to the count in element 3. If the content in element 3 is greater than the content in element 2, it is evident that the movement of the triggering edge caused an increase in T_{OFF}, which is desirable. Opposite result of comparison evidences that the movement of the triggering edge caused the undesirable decrease in T_{OFF}.

As long as T_{OFF} at the control FET continues to increase, the state machine will move the triggering edge further in the same direction in anticipation of further increase in T_{OFF}. The amount of movement may be the same as the last movement, i.e. one cycle of the system clock 5 or it may be progressively longer. The state machine may also store the number of repeated comparison results in a memory unit and uses the number of repeats as base to further adjust the amount of movement in the next switching cycle.

If a decrease in T_{OFF} is detected; the state machine will reverse the direction of the timing movement. In the next switching cycle, instead of further delaying the triggering edge of the signal that turns on the sync FET Sw2 it advances the triggering edge so the sync FET Sw2 will turn on one system clock period, for example, sooner with respect to the previous switching cycle. If the decrease of the T_{OFF} continues, the advancement of the triggering edge will also continue until T_{OFF} starts to increase and at this point the movement of the triggering edge timing will revert from advancement to delay.

The procedure described in the two previous paragraphs may continue during the operation of the converter so the triggering edge of the signal will seek out and dither about an optimal point where the conversion system efficiency is the optimized.

In FIG. 1, the element 4 is a pulse edge modulator. It receives signal from the constant time trigger unit 1, and from a comparator 9 that that compares the T_{OFF} measurements stored in memory units 2 and 3. The pulse edge modulator 4 moves the triggering edge of the signal that turns on the sync FET Sw2 back and forth to seek out the optimal timing and maximizes the conversion efficiency of the voltage converter.

The exemplary converter described above is operating in the constant on-time (COT) mode Because the on-time of the control FET Sw1 is fixed, the state machine modulates the switching timing of the sync FET Sw2 seeking the maximum turn-off-time of Sw1, which translates to minimum power input to the converter per switching cycle. This invention can be readily applied to converters that operate in a constant frequency mode, which will be described in the example 2 below.

Instead of measuring the off-time of the control FET Sw1, an alternate subject of the measurement is the sum of the off-time and the on-time of the control FET, The advantage of measure the total cycle time of the switching cycle is that higher resolution and better noise immunity.

### Example 2

Voltage converters that operate in constant frequency mode also can benefit with the inclusion of a state machine as described in Example 1. With a constant frequency voltage converter, both the on-time and the off-time of the control FET Sw1 may vary from switching cycle to switching cycle but the sum of the two is fixed. The system conversion efficiency can be optimized again by continuously moving (delaying or advancing) the triggering edge of the switching pulse at the sync FET Sw2 to seek the shortest on-time or the longest off-time at the control FET Sw1.

### Example 3

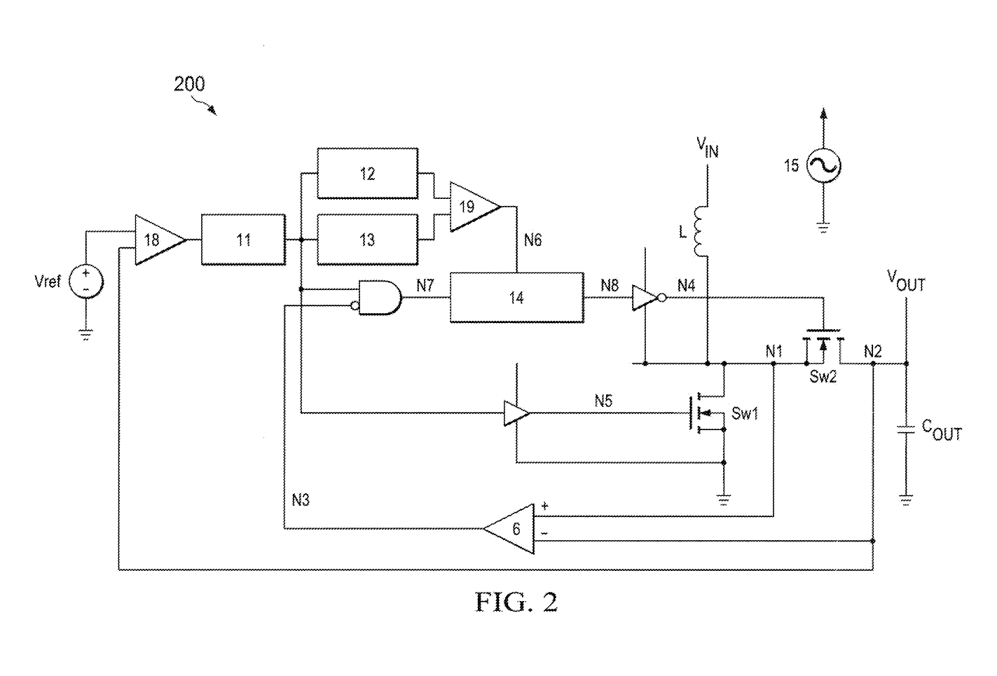

FIG. 2 depicts a boost converter 200, in which the output voltage is boosted by a circuit of an inductor, a capacitor, and two FETs to a higher voltage than the input voltage. The voltage input V_{IN} to the converter 200 is connected to one terminal of the inductor L and the output V_{OUT} is connected to the capacitor C_{OUT}. The other terminal of the inductor L is connected to the switch node between the control FET Sw1 and the sync FET Sw2.

Similar to the buck converter 100 depicted in FIG. 1, the converter 200 depicted in FIG. 3 embodies a state machine for enhancing the system power conversion efficiency. The state machine includes a comparator 19, a counter/memory unit 12, a second memory unit 13, a pulse edge modulator 14, and a digital power width modulator (PWM) controller 11. The PWM controller provides switching signal that switches the two FETs based on a feedback signal from the output terminal of he converter.

The converter 200 may be configured to operate in constant on-time (COT) mode or in the constant frequency mode. Constant on-time mode was described in detail in a example 1; the operation of the constant frequency mode will be described in more detail with the aid of converter 200 in this example. With the constant frequency mode, the FETs in the converter 200 both switch at a constant frequency—hence the sum of the on-time and the off-time of both FETs is constant.

The PWM controller 11 delivers a pulse train through the state machine to switch the FETs, During the period T_{ONSw1} the control FET Sw1 is turned on to draw power from the V_{IN} terminal to energize the inductor L; and during T_{OFFSw1} the control FET Sw1 is turned off and the stored power in the inductor is delivered to the load and to the capacitor C_{OUT}.

The turn-on time T_{ONSw1} of the control FET is counted in element 12 based on the system clock 15 and the count is compared to a reference stored in a memory unit 13. The reference stored in the memory unit 13 may be a count of the T_{ONSw1} of a previous switching cycle. The result of the comparison is fed to the pulse edge modulator 14. A positive signal from the comparator 19 may mean that the turn-on time of the Sw1 in the current switching cycle is longer than that of the previous switching cycle so more energy is delivered from the power source at V_{IN} to the converter. A negative signal from the comparator 19 signifies that less energy is delivered—which is desirable.

The pulse edge modulator 14 receives signals from the PWM controller 11 and from the comparator 19. The pulse edge moderator 14 is also configured to store the information such as the amount and the direction of the movement of the pulse edge of the triggering signal that switched on the sync FET Sw2 with respect to the previous triggering pulse.

During the following switching cycle, the state machine again counts the turn-on time of the control FET Sw1 and compared the count to the content of element 13, which by now contains the turn-on count of the previous switching cycle.

if the comparison determines that the turn-on time of the control FET Sw1 is decreasing, the movement of the triggering edge has resulted in reducing the amount of energy that went into the system in the switching cycle. The state machine then further moves the triggering edge of the next pulse in anticipation of further reduction of the turn-on time of the control FET Sw1. The amount of movement of the triggering edge may be the same as the last movement or it may not the same. It may be a multiple clock cycles of the system clock 16, or a time determined by a monotonic curve, or from a look-up table, based on the number of repeated positive determinations at the comparator 19.

if the comparison determines, however, that the turn-on time of the control FET Sw1 has increased with respect to the previous switching cycle, the movement of the triggering edge may have resulted in more energy flowing into the system in the last switching cycle. The state machine then prods the pulse edge modulator to reversely move the triggering edge of the next pulse in anticipation of halting and reversing the increasing of the turn-on time of he control FET Sw1.

The operation of the state machine continuously seeks out an optimal triggering pulse timing that results in the least amount of power that goes into the converter during its operation. This state machine does not try to time the turn-on and turn-off the FETs; but instead it urges the turn-on time of the control FET Sw1 to go down to reduce the duty cycle of the switch. In this way, the operation of this state machine makes the complexity or simplicity of the converter circuitry irrelevant. And it will self-correct and remain functional as designed even as the components of the converter go through normal aging process.

I claim:

1. A switching voltage converter, comprising:
a first switch coupled to a power source and a second switch coupled to the first switch;
a pulse controller configured to deliver a first pulse train of pulses to switch the first switch;
a counter configured to mea ire on-time and off-time of the first switch and store the measured counts;
a pulse edge modulator configured to move a triggering edge of pulses in a second pulse train based on the measured counts; and
the second switch configured to be switched by the pulses of the second pulse train.

2. The switching voltage converter of claim 1, in which the counter measure by counting the on-time and off-time based on the frequency of a system clock.

3. The switching voltage converter of claim 1, further comprising a state machine configured to compare the counts of consecutive pulses of the first pulse train and to move the triggering edge based on the comparisons.

4. The switching voltage converter of claim 3, in which the on-time is constant and the state machine is configured to measure and compare only the off-time of the pulses in the first pulse train.

5. The switching voltage converter of claim 3, in which the on-time is not constant and the state machine is configured to measure and compare only the off-time of the pulses in the first pulse train.

6. The switching voltage converter of claim 3, in which the state machine moves the triggering edge based further on history of a prior movement.

7. The switching voltage converter of claim 6, in which the history of the prior movement including amount of movement and direction of movement.

8. The switching voltage converter of claim 7, in which the state machine maintains the direction of the movement if an off-time measured is greater than an immediate prior off-time measurement.

9. The switching voltage converter of claim 7, in which the state machine reverses the direction of the movement if a measured off-time is less than an immediate prior off-time.

10. The switching voltage of claim 7, in which the amount of the movement is a function of the system clock period.

11. A method of operating a switching voltage converter, comprising:
providing a first switch coupled to a power source and a second switch coupled to the first switch;
providing a pulse controller configured to deliver a first pulse train of pulses to switch the first switch;
providing a counter configured to measure on-time and off-time of the first switch and store the measured counts;
providing a pulse edge modulator configured to move a triggering edge of pulses in a second pulse train based on the measured counts; and
configuring the second switch to be switched by the pulses of the second pulse train.

12. The method of claim 11, in which the counter measures by counting the on-time and off-time based on the frequency of a system clock.

13. The method of claim 11, further comprising providing a state machine configured to compare counts of consecutive pulses of the first pulse train and to move the triggering edge based on the comparisons.

14. The method of claim 13, in which the on-time is constant and the state machine is configured to measure and compare only the off-time of the pulses in the first pulse train.

15. The method of claim 13, in which the on-time is not constant and the state machine is configured to measure and compare only the off-time of the pulses in the first pulse train.

16. The method of claim 13, in which the state machine moves the triggering edge based further on history of a prior movement.

17. The method of claim 16, in which the history of the prior movement including amount of movement and direction of movement.

18. The method of claim 17, in which the state machine maintains the direction of the movement if an off-time measured is greater than an immediate prior off-time measurement.

19. The method of claim 17, in which the state machine reverses the direction of the movement if a measured off-time is less than an immediate prior off-time.

20. The method of claim 17, in which the amount of the movement is a function of the system clock period.
